(19) United States
(12) Patent Application Publication
(10) Pub. No.: US 2004/0265045 A1
(43) Pub. Date: Dec. 30, 2004

(54) Ball and socket joint and process for manufacturing same

(76) Inventors: Frank Nachbar, Lemforde (DE); Volker Grube, Diepholz (DE)

Correspondence Address: McGLEW AND TUTTLE, P.C., Counselors at Law, SCARBOROUGH STATION, SCARBOROUGH, NY, 10510-0827, US

(21) Appl. No.: 10/861,174

(22) Filed: Jun. 4, 2004

(30) Foreign Application Priority Data
Jun. 3, 2003 (DE) DE 103 25 280.0

(51) Int. Cl. F16D 1/12

(52) U.S. Cl. 403/122

(57) ABSTRACT

A joint ball (4) mounted movably within a bearing shell (5), is introduced into a joint housing (2.1 and 2.2), which is open on at least one side. At least one closing element (3.1 and 3.2) is connected with the joint housing (2.1 and 2.2) in a positive-locking manner. The positive-locking connection is established by the closing element (3.1 and 3.2) being placed indirectly or directly on the joint housing (2.1 and 2.2) and cold-formed in the edge area around a bead (8) of the joint housing (2.1 and 2.2).

### FIELD OF THE INVENTION

The present invention pertains to a ball and socket joint, preferably for use in a motor vehicle, comprising at least a joint housing, which is open on at least one side, and a joint ball, which is mounted movably within a bearing shell, and at least one closing element, which at least fixes the bearing shell in the joint housing indirectly or directly, wherein the joint housing has at least one bead in the area of the closing element, which bead directly partially surrounds the joint housing and is directed toward the outer area of the joint housing.

Furthermore, the present invention pertains to a process for manufacturing such a ball and socket joint.

### BACKGROUND OF THE INVENTION

Such a ball and socket joint may be used, for example, on a suspension arm of a motor vehicle.

The joint ball of the ball and socket joint, which usually has a pivot-like extension, is guided movably within a bearing shell and is mounted together with the bearing shell in a joint housing. After the mounting, the bearing shell shall be fixed within the joint housing and, in addition, the ball and socket joint shall be protected from penetrating dirt. The joint housing is connected for this purpose with a closing element, which presses the bearing shell into the joint housing.

A method of connecting the joint housing with the closing element can be obtained by welding together these two components at the edge. The heat generated during the welding operation and the introduction of heat into the joint are, however, undesired because of the stresses of the joint, which may sometimes occur as a result. Therefore, laser beam welding, in which the amount of heat introduced intro the component is small, is primarily suitable as a welding method. However, this welding method is extremely expensive because of the high purchase price of the laser and the auxiliary devices for adjusting and fixing the components.

Another possibility for connecting a joint housing with a closing element is already presented in the applicant's patent specification DE 43 01 303 C1, incorporated by reference. A mechanical connection of the joint housing and the closing element is generated according to this method by splitting a reinforced bead arranged in a special manner on the joint housing by means of a wedge-shaped tool. The material split off is shaped toward the closing element by another operation, and the closing element is inserted into the joint housing. The bearing shell and the joint housing are fixed by this deformation operation in the joint housing. As a result, a positive-locking connection is formed between the closing element and the joint housing. This mechanical connection method for connecting the closing element and the joint housing can be carried out in a substantially more favorable manner than the welding method. In order to produce the necessary bead with this process, the joint housing must be manufactured in a relatively complicated manner.

The joint housing is usually manufactured as a cold extruded pot (workpiece that was manufactured according to the cold flow pressing process) or according to the deep drawing process and then finished by additional process steps, for example, turning and milling. The use of stamped sheet metal joint housings is not yet possible or is possible to a limited extent only because of the poor deformation properties of stamped sheet metal housings.

### SUMMARY OF THE INVENTION

Because of increasing market requirements, one goal of the further development of such a ball and socket joint is to simplify the manufacture and to further reduce the manufacturing costs.

Correspondingly, the object of the present invention is to make available a ball and socket joint that can be manufactured even more rapidly and less expensively compared with the state of the art. Furthermore, an object of the present invention is to present a process that makes it possible to manufacture such a ball and socket joint.

These objects of the present invention are accomplished in terms of the subject with a ball and socket joint having the features of at least a joint housing which is open on at least one side, and a joint ball which is mounted movably within a bearing shell. At least one closing element is provided which at least fixes the bearing shell in the joint housing indirectly or directly. The joint housing has at least one bead in an area of the closing element. The bead extends at least partially around the joint housing and is directed toward the outer area of the said joint housing. The closing element extends around the bead of the joint housing in the edge area in a positive-locking manner.

The object of the present invention is accomplished by manufacturing a ball and socket joint in which the joint ball which is mounted movably within a said bearing shell is introduced into a joint housing which is open on at least one side. The at least one closing element is connected with the joint housing in a positive-locking manner. The closing element is placed indirectly or directly on the joint housing and is cold-formed in the edge area around the bead of the joint housing. Advantageous variants of the present invention are the subject of subclaims.

The inventors have recognized that the number of process steps involved in connecting the joint housing with the closing element can be reduced and the manufacture of the joint housing can be simplified if instead of the joint housing, the closing element is deformed for connecting the two components.

Thus, the inventors suggest that a ball and socket joint, preferably one for use in a motor vehicle, comprising at least a joint housing that is open on at least one side and a joint ball, which is mounted movably within a bearing shell, and at least one closing element, which at least fixes the bearing shell in the joint housing indirectly or directly, wherein the joint housing has at least one bead in the area of the closing element, which said bead extends at least partially around the joint housing and is directed toward the outer area of the joint housing, be improved such that the closing element surrounds the at least one bead of the joint housing in the edge area in a positive-locking manner.

It is achieved as a result that the joint housing does not have to be manufactured primarily as a cold-extruded pot or according to the deep drawing process any longer, in which case the joint housing must be subjected to further finishing operations because of the low manufacturing tolerances required. The joint housing can now be manufactured, for example, as a sheet metal component by stamping. Since no deformation operations need to be performed on the joint housing itself, finishing of the joint housing can be eliminated. In addition, the mechanical connection of the closing element with the joint housing can be established more rapidly. The closing element can be edged in the edge area shortly after it has been placed on the joint housing, as a result of which a positive-locking connection is established between the closing element and the joint housing. The inventors point out the fact that it is, however, also possible to use joint housings that were manufactured according to the manufacturing processes used primarily until now in the novel ball and socket joint.

It is favorable if the closing element closes the joint housing. The movable joint ball is protected as a result from penetrating dirt within the bearing shell.

The closing element may be designed as a housing cover. As a result, large surfaces can be covered by a component that can be manufactured at low cost in a dustproof manner.

In another favorable embodiment, the closing element is designed as a closing ring. A sealing bellows may be fastened at the same time to the closing ring, which fixes the bearing shell in the joint housing. This closing ring thus represents a tight closing site for the sealing bellows.

It is advantageous if the joint ball has a pivot pin. The ball and socket joint can be used as a result in the area of the suspension arm in a motor vehicle.

The bead on the joint housing can extend over the joint housing over its entire circumference. The circumferential bead increases the rigidity of the joint housing and, in addition, a larger support and contact surface is made available by the surface of the bead for the closing element, as a result of which uniformly tight closure of the joint housing is guaranteed.

If the bead extends around the joint housing over its entire circumference, it is correspondingly favorable if the at least one edging of the closing element also extends fully around the said closing element. As a result, the bearing shell can be fixed in the joint housing by the closing element with a stronger pressing force.

Furthermore, it is advantageous if the closing element and/or the joint housing are manufactured by working without cutting. As a result, the components of the ball and socket joint can be manufactured in larger lots and at a lower cost compared with parts manufactured by the time-consuming cutting manufacturing process.

Thus, it is favorable to manufacture the closing element and/or the joint housing exclusively by at least one stamping operation.

The ball and socket joint may have a connection with at least one chassis component of a motor vehicle. For example, the ball and socket joint may be arranged on a suspension arm of a motor vehicle.

Presenting a process for manufacturing a ball and socket joint is also in keeping with the present invention. A joint ball, which is mounted movably within a bearing shell, is introduced in this process into a joint housing, which is open on at least one side, and at least one closing element is connected with the joint housing in a positive-locking manner. This positive-locking connection of the closing element with the joint housing is produced in this process by the closing element being placed indirectly or directly on the joint housing and cold-formed in the edge area around a bead of the joint housing.

The novel process offers some advantages over the prior-art manufacturing process for manufacturing a ball and socket joint, in which the positive-locking connection is achieved by deforming the joint housing. Thus, the closing element is placed on the joint housing in nearly one operation in the novel process and edged in the edge area shortly thereafter. The closing element was placed on the joint housing in a first step in the previous process, and the bead of the joint housing was deformed toward the closing element in a second step. This time saving in the manufacture of a ball and socket joint becomes noticeable especially in case of large lots.

Since the bead of the joint housing was deformed in the previous manufacturing process, it was possible to use only joint housings that permitted a deformation of the material in the area of the bead. Thermoplastic and duroplastic plastics were not able to be used as the joint housing with this process.

In contrast, the novel process makes it possible to use joint housings that were manufactured according to various processes, some of which will be listed below.

The joint housing may be manufactured, for example, by cold forming. Another possibility is the manufacture of the joint housing according to the stamping technique.

As an alternative to this, the joint housing may, however, also be cast or injection molded. For example, it is thus also possible to use joint housing bodies made of cast metals, e.g., gray cast iron, or from injection-molded thermoplastic or duroplastic plastics.

Furthermore, the novel process makes it possible to injection mold the joint housing and the bearing shell together and to connect them at least to one another. Consequently, it is now conceivable to manufacture the joint housing and the bearing shell as an injection-molded body.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a side view of a prior-art ball and socket joint with a closing cover;

FIG. 2 is a side view of a prior-art ball and socket joint with a closing ring;

FIG. 3 is a sectional view of a novel ball and socket joint with a closing ring; and

FIG. 4 is a sectional view of a novel ball and socket joint with a closing cover.

### DESCRIPTION OF THE PREFERRED EMBODIMENT

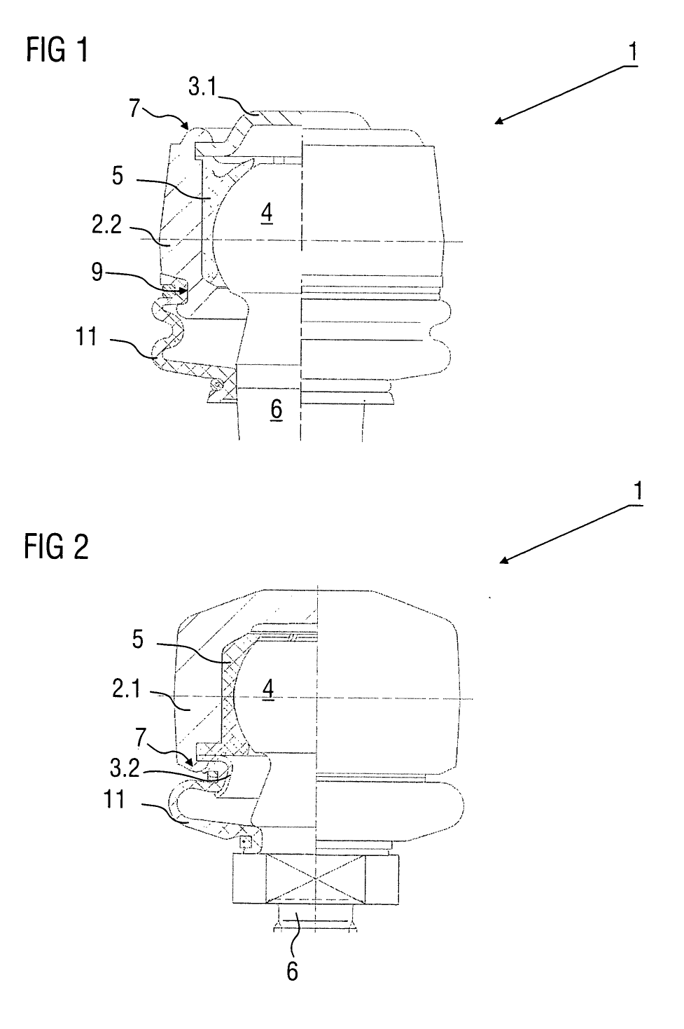

FIG. 1 shows a side view of a prior-art ball and socket joint 1 with a closing cover 3.1. The right-hand half of FIG. 1 shows a view of the outer surface of the ball and socket joint 1. The left-hand half of the figure shows a sectional view through the middle of the ball and socket joint 1. The ball and socket joint 1 comprises in this embodiment a joint housing 2.2, which is open on both sides and is closed in an annular pattern. This joint housing 2.2, which is open on both sides, accommodates the bearing shell 5 in the interior of the housing. The joint ball 4 is movably embedded in this bearing shell 5. In order to make it possible to fix the bearing shell 5 within the joint housing 2.2, which is open on both sides, a closing cover 3.1, which is pressed on by a deforming contour 7, is inserted at the upper opening of the joint housing 2.2, which is open on both sides. The deforming contour 7 is prepared by means of a special tool by deforming areas of material in the upper area of the joint housing 2.2, which is open on both sides, toward the interior of the housing. The closing cover 3.1 and the bearing shell 5 are pressed by this deforming contour 7 onto/into the joint housing 2.2, which is open on both sides. The closing cover 3.1 in the upper area acts at the same time as a barrier against penetrating dirt.

A circumferential groove 9 is milled into the outer edge of the lower opening of the joint housing 2.2, which is open on both sides. The pivot 6 of the joint ball ends at the lower opening of the joint housing 2.2, which is open on both sides. To prevent dirt from penetrating into the area of the pivot 6, a sealing bellows 11 is arranged at the lower opening of the joint housing 2.2, which is open on both sides. This sealing bellows 11 surrounds the pivot 6 of the joint ball and engages the groove 9 of the joint housing 2.2, which is open on both sides. Movement of the pivot 6 is additionally prevented by the sealing bellows 11.

FIG. 2 shows a side view of another prior-art embodiment of a ball and socket joint 1 with a closing ring 3.2. The right-hand half of FIG. 2 shows a view of the outer surface of the ball and socket joint 1. A sectional view through the middle of the ball and socket joint 1 is shown in the left-hand half of the figure. The ball and socket joint 1 comprises in this embodiment a joint housing 2.1, which is open on one side and has a pot-shaped design. This joint housing 2.1, which is open on one side, accommodates the bearing shell 5 in the interior of the housing. The joint ball 4 is embedded movably in this bearing shell 5. In order to make it possible to fix the bearing shell 5 within the joint housing 2.1, which is open on one side, a closing ring 3.2, which is pressed on by a deforming contour 7, is inserted at the lower opening of the joint housing 2.1, which is open on one side. The deforming contour 7 is produced by means of a special tool by deforming areas of material in the lower area of the joint housing 2.1, which is open on one side, toward the interior of the housing. The closing ring 3.2 and the bearing shell 5 are pressed by this deforming contour 7 onto/into the joint housing 2.1, which is open on one side. A sealing bellows 11, which prevents dirt from penetrating into the interior of the joint housing and at the same time makes possible the mobility of the pivot 6, likewise acts on the lower side of the closing ring 3.2 and directly on the shaft of the pivot 6.

The drawback of the ball and socket joints shown in FIGS. 1 and 2 is that their joint housings must have a special design in order to make it possible to accommodate the closing ring or the closing cover and to connect these with the joint housing. The edge must be able to be deformed in the area of the opening/openings of the joint housing, i.e., a displacement of material must be made possible. Joint housings made of stamped sheet metal are unsuitable here, because the shape of sheet metal housings can be adapted only with difficulty if at all. The joint housing was therefore made mostly according to the cold extrusion process or the deep drawing process. Furthermore, it may happen that the area for receiving the closing cover or the closing ring must be finished by a turning and/or milling operation.

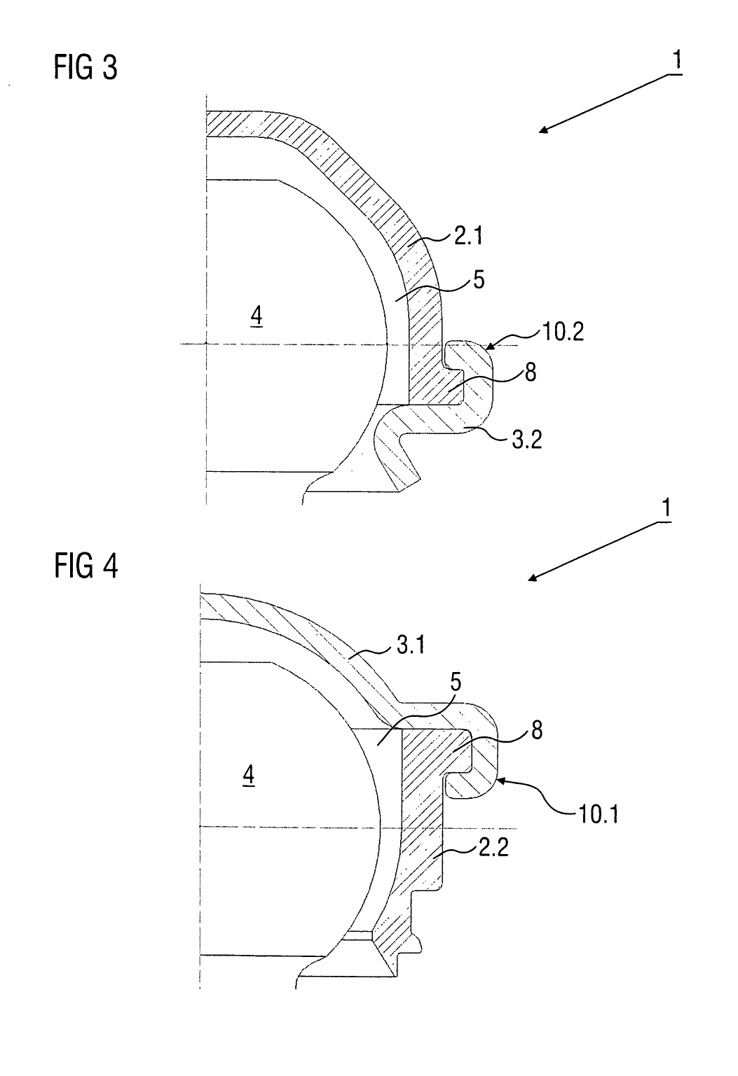

FIGS. 3 and 4 show two possible special embodiments of the ball and socket joint according to the present invention. These embodiments of the ball and socket joint make it possible to eliminate the need either for deforming the joint housing in the edge area or for finishing the joint housing. Since no deformation processes are necessary on the joint housing during the fastening of the closing cover and the closing ring on the joint housing, it is now also possible to use joint housings that were manufactured according to the stamping process.

FIG. 3 shows a sectional view of a novel ball and socket joint 1 with a closing ring 3.2. The ball and socket joint 1 comprises in this embodiment a joint housing 2.1, which is open on one side and has a pot-shaped design. This joint housing 2.1, which is open on one side, was manufactured according to the stamping process and has a bead 8 directed toward the outside of the housing in the area of the lower opening. Analogously to FIGS. 1 and 2, the joint housing 2.1 accommodates the bearing shell 5 in the interior of the housing. The joint ball 4 is embedded movably in this bearing shell 5. In order to make it possible to fix the bearing shell 5 within the joint housing 2.1, which is open on one side, a closing ring 3.2 is placed on the lower opening of the joint housing 2.1, which is open on one side. This closing ring 3.2, which may also be stamped from a piece of sheet metal, is connected with the joint housing in a positive-locking manner by means of an edging 10.2, which extends around the bead 8 of the joint housing 2.1, which is open on one side.

FIG. 4 shows a sectional view of a novel ball and socket joint 1 with a closing cover 3.1. The ball and socket joint 1 comprises in this embodiment a joint housing 2.2, which is open on both sides and is closed in an annular pattern. This joint housing 2.2, which is open on both sides, was manufactured according to the deep drawing process and has a bead 8 directed toward the outside of the housing in the area of the upper opening. The joint housing 2.2 accommodates the bearing shell 5 in the interior of the housing. The joint ball 4 is embedded movably in this bearing shell 5. In order to make it possible to fix the bearing shell 5 within the joint housing 2.2, which is open on both sides, a closing cover 3.1 is placed on the upper opening of the joint housing 2.2, which is open on both sides. This closing cover 3.1 is connected with the joint housing 2.2 in a positive-locking manner by means of an edging 10.1, which extends around the bead 8 of the joint housing 2.2, which is open on both sides. A circumferential groove 9, which is used to receive the sealing bellows 11, is milled into the outer area of the lower opening of the joint housing 2.2, which is open on both sides. The sealing bellows is not shown in FIG. 4.

Consequently, the present invention makes available, on the whole, a ball and socket joint and a process for manufacturing same, in which a joint ball, which is mounted movably within a bearing shell, is introduced into a joint housing, which is open on at least one side, and at least one closing element is connected with the joint housing. The positive-locking connection is generated by the closing element being placed indirectly or directly on the joint housing and cold-formed in the edge area around a bead of the joint housing.

In this ball and socket joint and in the novel process, the joint housing does not need to be subjected to further processing, as a result of which the ball and socket joint as a whole can be manufactured in a very short time and consequently at a low cost.

It is obvious that the above-mentioned features and the features of the patent claims are applicable not only in the particular combinations specifically described, but also in other combinations or alone without going beyond the scope of the present invention.

While a specific embodiment of the invention has been shown and described in detail to illustrate the application of the principles of the invention, it will be understood that the invention may be embodied otherwise without departing from such principles.

What is claimed is:

1. A ball and socket joint comprising:
a joint housing which is open on at least one side;
a bearing shell mounted in said joint housing;
a joint ball mounted movably within said bearing shell;
a closing element fixing said bearing shell in said joint housing one of indirectly and directly, said joint housing having a bead in an area of said closing element, said bead extending at least partially around said joint housing and directed toward an outer area of said joint housing, said closing element extending around said bead of said joint housing in an edge area in a positive-locking manner.

2. A ball and socket joint in accordance with claim 1 wherein:
said closing element closes said joint housing.

3. A ball and socket joint in accordance with claim 1, wherein:
said closing element is designed as a housing cover.

4. A ball and socket joint in accordance with claim 1 wherein:
said closing element is designed as a closing ring:
a sealing bellows fastened to said closing ring.

5. A ball and socket joint in accordance claim 1, wherein:
said joint ball has a joint pin.

6. A ball and socket joint in accordance with claim 1 wherein:
said bead extends completely around said joint housing.

7. A ball and socket joint in accordance with claim 1 wherein:
said edge area of said closing element extends completely around said closing element.

8. A ball and socket joint in accordance with claim 1 wherein:
said closing element comprises a workpiece which is manufactured by working without cutting.

9. A ball and socket joint in accordance with claim 8, wherein:
said closing element comprises a workpiece that is manufactured exclusively by at least one stamping operation.

10. A ball and socket joint in accordance with claim 1 wherein:
said joint housing comprises a workpiece that is manufactured by working without cutting.

11. A ball and socket joint in accordance with claim 10 wherein:
said joint housing comprises a workpiece that is manufactured exclusively by at least one stamping operation.

12. A ball and socket joint in accordance with claim 1 further comprising:
a connection with at least one chassis component of a motor vehicle.

13. A ball and socket joint in accordance with patent claim 12, wherein:
said ball and socket joint is arranged on a suspension arm of a motor vehicle.

14. A process for manufacturing a said ball and socket joint, the process comprising the steps of:
providing a joint housing which is open on at least one side;
providing a bead extending at least partially around said joint housing and directed toward an outer area of said joint housing;
mounting a bearing shell in said joint housing;
movably mounting a joint ball within said bearing shell;
providing a closing element with an edge area;
placing said closing element one of indirectly and directly on said joint housing;
cold-forming said edge area of said closing element around a bead of said joint housing.

15. A process in accordance with claim 14, further comprising:
cold-forming said joint housing.

16. A process in accordance with claim 14, further comprising:
stamping said joint housing.

17. A process in accordance with claim 14, further comprising:
one of casting and injection molding said joint housing.

18. A process in accordance with claim 17, further comprising:
injection molding said joint housing and said bearing shell together;
connecting said joint housing and said bearing shell to one another at least indirectly.
